(19) United States
(12) Patent Application Publication
(10) Pub. No.: US 2023/0297964 A1
(43) Pub. Date: Sep. 21, 2023

(54) PAY EQUITY FRAMEWORK

(71) Applicant: Salary.com, LLC, Waltham, MA (US)

(72) Inventors: Gregory Kent Plunkett, Wellesley, MA (US); Yong Zhang, Wellesley, MA (US); Heidi Ambler, Intervale, NH (US); Alden Aikins, Concord, MA (US); Lan Cheng, Marlborough, MA (US); David Cross, North Reading, MA (US); Jennifer Demore, Haverhill, MA (US); Carol Ferrari, Upton, MA (US); Christopher Fusco, Millis, MA (US); Helene Gold, Framingham, MA (US); Conor Himstead, Somerville, MA (US); Christopher Knize, Franklin, MA (US); Andrew Linn, Dennis, MA (US); Patricia Mulkeen, North Eastham, MA (US); Caitlin Schiattareggia, Boston, MA (US); Garry Straker, South Glastonbury, CT (US); Jonathan Sweet, Burlington, MA (US); David Turetsky, Franklin, MA (US)

(21) Appl. No.: 18/121,851

(22) Filed: Mar. 15, 2023

Related U.S. Application Data
(60) Provisional application No. 63/320,116, filed on Mar. 15, 2022.

(51) Int. Cl. G06Q 10/1053; H04L 9/40

(52) U.S. Cl. CPC G06Q 10/1053; H04L 63/101

(57) ABSTRACT

A method, a system, and computer program product for managing pay equity cloud-based software applications are provided. A query for compensation data for an employment position associated with a macro-entity is received. The employment position is defined by parameters associated with a micro-entity. The compensation data for similar employment positions associated with the macro-entity is retrieved, from a database and by using the parameters. The compensation data is processed to generate grouped and ranked employment positions. Compensation gaps between the ranked employment positions are determined, by executing a multivariate regression analysis including an analysis of one or more cohorts of employment positions within the ranked employment positions. A recommendation for adjusting compensation associated with one or more employment positions is generated, by using a machine learning model. An instruction to display a notification including the recommendation is provided.

### CROSS-REFERENCE TO RELATED APPLICATIONS

The present application claims priority to U.S. Provisional Patent Appl. No. 63/320,116, filed Mar. 15, 2022, and entitled “PAY EQUITY FRAMEWORK” and incorporates its disclosure herein by reference in its entirety.

### BACKGROUND

Technology has been used to implement a connection between compensation and equity at work. Compensations serve as a quantitative measure of an employee's value relative to multiple rules designed to encompass definitions of the employer to employee relationship. Some of the rules used to determine the quantitative measure of an employee's value are limited to particular settings, raising difficulties in implementing them for all employees of a company. Even macro-entities that employ systems and methods configured for determination of pay equity framework might lack transparency. The lack of transparency can make it difficult for employees to determine whether they are being paid fairly, and also if other persons in the company are paid fairly.

### SUMMARY

Methods, systems, and articles of manufacture, including computer program products, are provided for machine learning based determination of pay equity framework. In one aspect, a system includes: one or more computer processors, a database storing a plurality of documents including job related documents, and a data processing system, executable upon the one or more computer processors, to perform operations. The operations include: receiving a query for compensation data for an employment position associated with a macro-entity, the employment position being defined by a plurality of parameters associated with a micro-entity, retrieving, from a database and by using the plurality of parameters, the compensation data for similar employment positions associated with the macro-entity, processing the compensation data to generate ranked employment positions, by grouping and ranking the similar employment positions associated with the macro-entity, determining one or more compensation gaps between the ranked employment positions, by executing a multivariate regression analysis including an analysis of one or more cohorts of employment positions within the ranked employment positions, generating, by using a machine learning model including a convolution function configured to process the one or more compensation gaps, a recommendation for adjusting compensation associated with one or more employment positions, and providing an instruction to display a notification including the recommendation.

In some variations, one or more features disclosed herein including the following features can optionally be included in any feasible combination. In some implementations, the operations further include: determining, using a machine learning, a compensation equity for each employment position within groups of similar employment positions. In some implementations, the operations further include: performing a user authentication, determining whether the query for the compensation data originates from a whitelisted server, and retrieving, from a database, via a secure gateway, the compensation data associated with the macro-entity. In some implementations, the compensation data is encrypted for transmission, via a secure gateway. In some implementations, the operations further include: generating a notification indicating completion of an analysis of a compensation equity. In some implementations, the compensation data include data recorded over a past period of time, encrypted, and stored in a distributed database of a system. In some implementations, the compensation data include external values associated with the macro-entity.

In another aspect, a non-transitory computer-readable storage medium includes programming code, which when executed by at least one data processor, causes operations including: receiving a query for compensation data for an employment position associated with a macro-entity, the employment position being defined by a plurality of parameters associated with a micro-entity, retrieving, from a database and by using the plurality of parameters, the compensation data for similar employment positions associated with the macro-entity, processing the compensation data to generate ranked employment positions, by grouping and ranking the similar employment positions associated with the macro-entity, determining one or more compensation gaps between the ranked employment positions, by executing a multivariate regression analysis including an analysis of one or more cohorts of employment positions within the ranked employment positions, generating, by using a machine learning model including a convolution function configured to process the one or more compensation gaps, a recommendation for adjusting compensation associated with one or more employment positions, and providing an instruction to display a notification including the recommendation.

In some variations, one or more features disclosed herein including the following features can optionally be included in any feasible combination. In some implementations, the operations further include: determining, using a machine learning, a compensation equity for each employment position within groups of similar employment positions. In some implementations, the operations further include: performing a user authentication, determining whether the query for the compensation data originates from a whitelisted server, and retrieving, from a database, via a secure gateway, the compensation data associated with the macro-entity. In some implementations, the compensation data is encrypted for transmission, via a secure gateway. In some implementations, the operations further include: generating a notification indicating completion of an analysis of a compensation equity. In some implementations, the compensation data include data recorded over a past period of time, encrypted, and stored in a distributed database of a system. In some implementations, the compensation data include external values associated with the macro-entity.

In another aspect, a computer-implemented method includes: at least one data processor; and at least one memory storing instructions, which when executed by the at least one data processor, cause operations including: receiving a query for compensation data for an employment position associated with a macro-entity, the employment position being defined by a plurality of parameters associated with a micro-entity, retrieving, from a database and by using the plurality of parameters, the compensation data for similar employment positions associated with the macro-entity, processing the compensation data to generate ranked employment positions, by grouping and ranking the similar employment positions associated with the macro-entity, determining one or more compensation gaps between the ranked employment positions, by executing a multivariate regression analysis including an analysis of one or more cohorts of employment positions within the ranked employment positions, generating, by using a machine learning model including a convolution function configured to process the one or more compensation gaps, a recommendation for adjusting compensation associated with one or more employment positions, and providing an instruction to display a notification including the recommendation.

In some variations, one or more features disclosed herein including the following features can optionally be included in any feasible combination. In some implementations, the computer-implemented method further includes: determining, using a machine learning, a compensation equity for each employment position within groups of similar employment positions. In some implementations, the computer-implemented method further includes: performing a user authentication, determining whether the query for the compensation data originates from a whitelisted server, and retrieving, from a database, via a secure gateway, the compensation data associated with the macro-entity. In some implementations, the compensation data is encrypted for transmission, via a secure gateway. In some implementations, the computer-implemented method further includes: generating a notification indicating completion of an analysis of a compensation equity. In some implementations, the compensation data include data recorded over a past period of time, encrypted, and stored in a distributed database of a system. In some implementations, the compensation data include external values associated with the macro-entity.

Implementations of the current subject matter can include systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein can be apparent from the description and drawings, and from the claims. While certain features of the currently disclosed subject matter are described for illustrative purposes, it should be readily understood that such features are not intended to be limiting. The claims that follow the disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of machine-learning based continuous pay equity analysis system, according to some implementations of the current subject matter;

FIG. 2A illustrates an example of machine-learning based continuous pay equity analysis process, according to some implementations of the current subject matter;

FIG. 2B illustrates further details of one of the operations shown in FIG. 2A, according to some implementations of the current subject matter;

FIG. 2C illustrates further details of the modeling operation, according to some implementations of the current subject matter;

FIG. 3 illustrates an example of system, according to some implementations of the current subject matter; and

FIG. 4 illustrates an example of a process, according to some implementations of the current subject matter.

### DETAILED DESCRIPTION

Implementations of the present disclosure are generally directed to software application based quantification of pay equity. More particularly, implementations of the present disclosure are directed to machine learning based determination of pay equity framework. The pay equity framework can be used to define how macro-entities (e.g., organizations) approach their relationship with affiliated micro-entities (e.g., employees), altering how workplace culture and engagement are fostered. Macro-entities that opt out from implementing pay equity systems are exposed to different risks, including legal risks.

Traditional technologies configured to implement pay equity were based on a definition of equal pay for comparable work. The traditional configuration of pay equity technologies often did not encompass all aspects of the pay equity equation. For example, some traditional configurations of pay equity technologies did not encompass that pay equity may be defined as equal pay for comparable work that is internally equitable, externally competitive, and transparently communicated. Historically, pay equity was related to the practice of discrimination testing and reporting for compliance purposes, and limited by the confines of satisfying government reporting requirements.

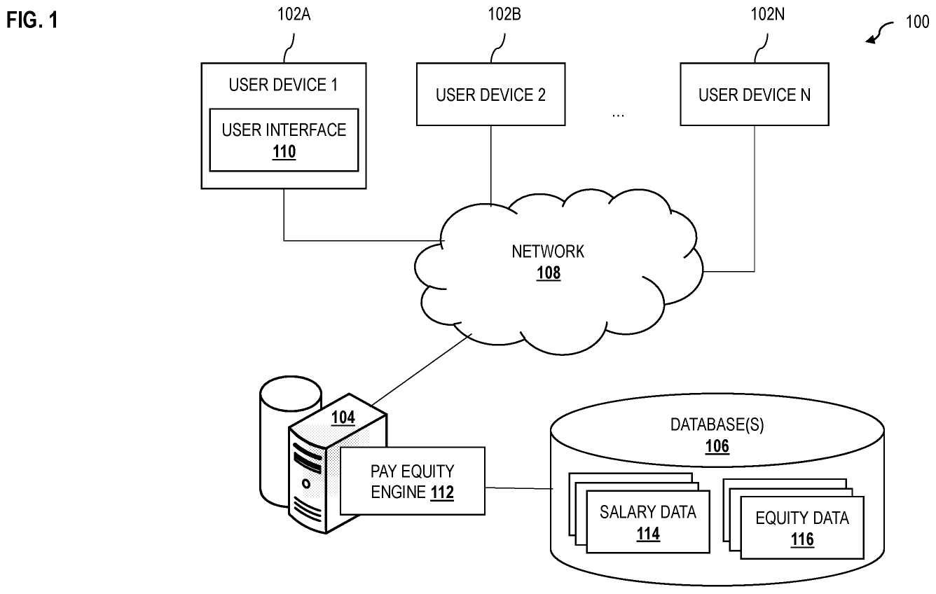

To avoid the drawbacks of traditional pay equity technologies described above, machine learning based determination of pay equity framework is used to accurately determine how pay equity impacts compensation for all micro-entities, adopting a framework that analyses the macro-entity as a whole and beyond compliance reporting. The implementations described herein, dictate that macro-entities shift from pure market pricing to a broader pay equity approach when determining compensation. Using the implementations described herein, the pay equity framework provides a comprehensive solution that reflects through multiple rules and definitions the internal and external parameters affecting the pay equity of a macro-entity, promoting transparency of results to the affiliated micro-entities. The visibility of the pay equity, enables elimination of compensation distribution uncertainties, minimizing incidents and optimizing computational resources involved in pay equity management. The described implementations improve the pay equity systems by minimizing repeated requests through minimizing incidents, which decreases CPU processing demands and network resources, enabling the respective systems to handle more processes. In some implementations, the implementations described herein address the above limitations of conventional systems by providing a machine-learning based continuous pay equity analysis (CPE) method, framework, and system for compensation management with a six-step benchmarking and micro-entity communication process, as described with reference to FIGS. 1-4.

FIG. 1 illustrates an example system 100 configured for machine-learning based continuous pay equity analysis, according to some implementations of the current subject matter. The example system 100 can include one or more user devices 102 (e.g., user 1 devices 102A, user 2 devices 102B, . . . user n devices 102N), a data processing system 104, one or more database(s) 106, and a network 108.

The user devices 102 can include one or more devices communicatively coupled with the data processing system 104 to access pay equity applications. The user devices 102 can be and/or include any type of processor and memory based device, such as, for example, cellular phones, smart phones, tablet computers, laptop computers, desktop computers, workstations, personal digital assistants (PDA), network appliances, cameras, enhanced general packet radio service (EGPRS) mobile phones, media players, navigation devices, email devices, game consoles, or an appropriate combination of any two or more of The devices or other data processing devices. The user devices 102 can include different computing system configurations, such as different operating systems, different processing capabilities, different hardware components, and/or other differences can concurrently request pay equity services, from the data processing system 104. The user devices 102 can include any combination of fixed and variable computing components. The user devices 102 can include a user interface 110. The user interface 110 can include an input interface and an output interface. The input interface includes a component that permits the user devices 102 to receive information, such as via user input (e.g., a touchscreen display, a keyboard, a keypad, a mouse, a button, a switch, a microphone, a camera, and/or the like). The output interface includes a component that provides output information from the user devices 102 (e.g., a display, a speaker, one or more light-emitting diodes (LEDs), and/or the like). The user interface 110 of the user devices 102 can enable access of a pay equity engine 112 provided as a service by the data processing system 104. For example, the user interface 110 of the user devices 102 can enable access to a software application, such as a cloud-based software application providing a variety of data processing functionalities including, for example, authentication services, job selection, equity management, pay equity, and/or the like.

The data processing system 104 can include any form of servers including, but not limited to a web server (e.g., cloud-based server), an application server, a proxy server, a network server, and/or a server pool. The data processing system 104 can include the pay equity engine 112 and the database 106. The data processing system 104 can include a secure gateway to receive historical data from the database 106. The pay equity engine 112 can provide equity management, equity analyses, and/or pay equity services for any type of jobs recorded for a macro-entity associated with multiple groups of micro-entities. The pay equity engine 112 can implement at least one machine learning (ML) model (e.g., at least one multilayer perceptron (MLP), at least one convolutional neural network (CNN), at least one recurrent neural network (RNN), at least one data encoder, at least one equity converter, and/or the like) and/or statistical (regression) models. In some examples, pay equity engine 112 can implement at least one ML model as part of an equity analysis process (e.g., a pipeline for identifying one or more job characteristics in a micro-entity and/or the like). The pay equity engine 112 can be configured to process equity data retrieved from the database 106 to execute equity analysis and provide pay equity recommendations.

The database 106 can store salary data 114 associated with equities of a user (micro-entity or macro-entity representative) of the user devices 102 and equity data 116 (including validated pay equity data). The database 106 can include a multitenant database architecture (e.g., multitenant database containers (MDC)), such that each tenant of the data processing system 104 (using respective user devices 102) can customize respective equity data stored by the database 106 and can be served by separate instances of the data processing system 104 when using cloud-based software applications accessible through the pay equity engine 112. The database 106 can include a cloud database system environment, although other types of databases can be used as well. In some implementations, the database 106 can include a publicly accessible database. The database(s) 106 may be configured to store various information, data, files, etc., which may include at least one of the following: a video, an audio, an image, a graphics data, a text data, and/or any other information, data, file, and/or any other data file (“data file”). Such data file may be related to various parameters associated with compensation data, demographics, age, geographical locations, and/or any other data. The database 106 can include a runtime database that holds most recent salary data 114 and equity data 116. The database 106 can store any type of data that can be updated in real time and can be used by the data processing system 104 for equity analysis and pay equity recommendations.

The network 108 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like.

With continued reference to FIG. 1, one or more functions are described as being performed by the example system 100. The number and arrangement of the components and/or devices of the example system 100, shown in FIG. 1 are provided as an example. There may be additional systems and/or devices, fewer systems and/or devices, different systems and/or device, or differently arrangement systems and/or devices than those shown in FIG. 1. Furthermore, two or more systems and/or devices show in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of the example system 100 may perform one or more functions described as being performed by another set of systems or another set of devices of the example system 100.

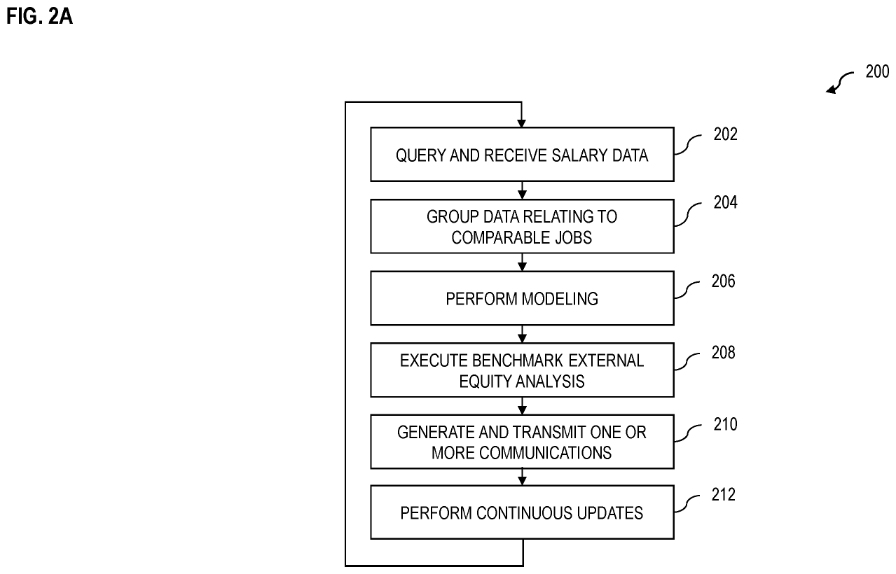

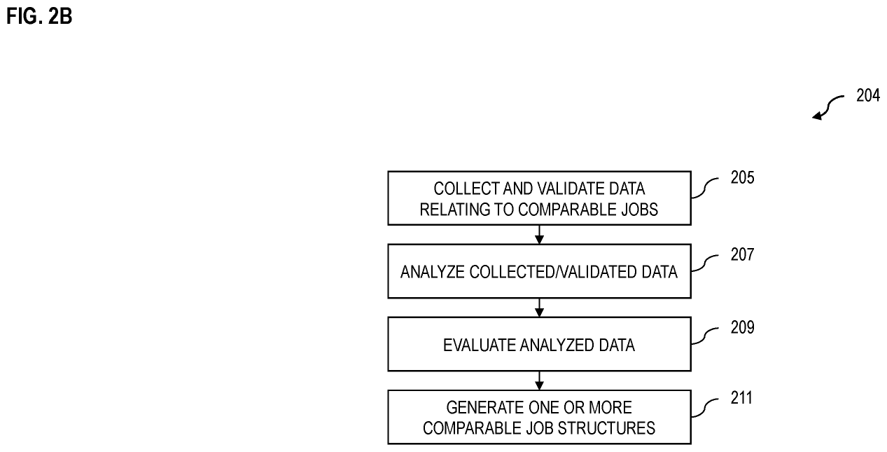

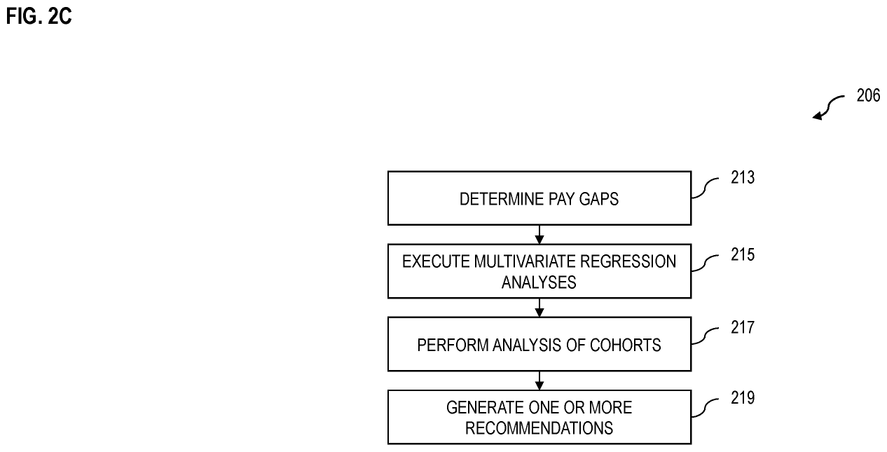

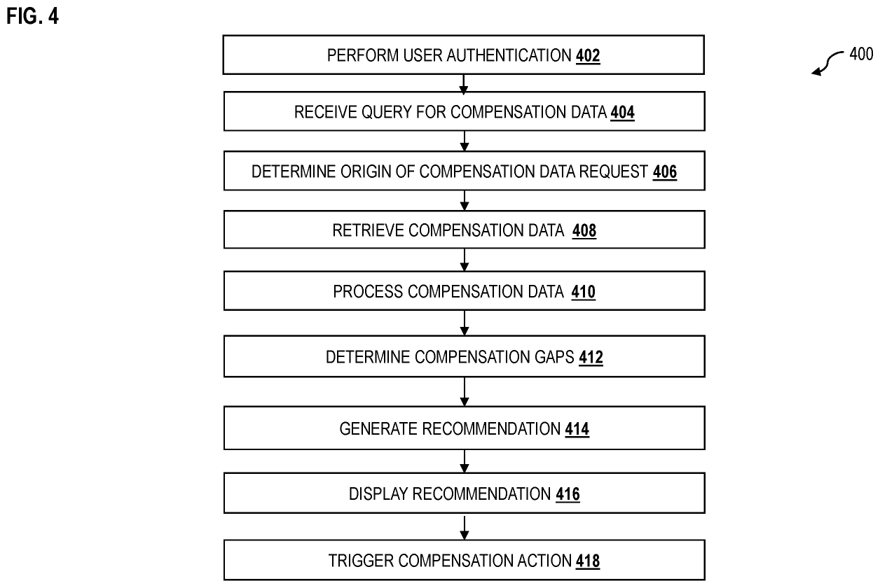

The user interface 110 can enable an entry of a user input including user authentication information, data (e.g., micro-entity and macro-entity identifiers that can be processed by the pay equity engine 112) associated to a particular job (employment position), such as job identification (e.g., name and type of job), and requested analysis for the data processing system 104. In general, the data processing system 104 uses the pay equity engine 112 to manage equity analyses and generate recommendations that can be transmitted to the user devices 102 to be displayed by the user interfaces 110. The data processing system 104 can be configured to provide access, during authenticated sessions, to cloud-based software applications of the data processing system 104 for equity customization services, to any number of user devices (e.g., the user devices 102) over the network 108. In some example implementations, the data processing system 104 can operate on data stored in one or more databases 106. For example, the data processing system 104 can store, retrieve, update, and/or delete data from the database 106 and can generate an accurate pay estimate. In some implementations, the data processing system 104 can transmit data to the database 126 to modify equity data 116 based on actions performed in response to generated recommendations. The equity analysis and recommendation process is further described in detail with reference to FIGS. 2A-2C and 4.

FIG. 2A illustrates an example of machine-learning based continuous pay equity analysis process 200, according to some implementations of the current subject matter. The process 200 may be performed by the example system 100 and in particular, by the data processing system 104, described with reference to FIG. 1.

At 202, the example system 100 may be configured to query and receive compensation data. Compensation data can include historical data indicative of a job (employment position) type, experience level, and compensation data during a set time period. The compensation data can be used for pay equity analysis and determination. Pay equity analysis can include a definition of payment criteria, which may state that pay equity is mandated by organization leadership as well as board of directors of the macro-entity. The macro-entity can adjust the payment criteria over time to ensure a balance between external competitiveness and internal equity. The macro-entity can use a pay equity engine (e.g., pay equity engine 112 described with reference to FIG. 1) to provide a pay equity analysis for transparent communication with multiple micro-entities associated with (e.g., under contract with or hired by) the macro-entity. The compensation data can be used can be used to provide transparency related to current salaries relative to those in the established and relevant external and internal labor markets. The compensation data can be used to determine a pay philosophy that is consistent with organizational objectives, being sustainable according to a current and future financial strength of the macro-entity.

The compensation data can include various aspects of a pay equity process defined by the macro-entity. One aspect can relate to alignment, which may be used to confirm leadership support for a sustainable pay equity process that is aligned with macro-entity values and culture and supports strategic goals and budgeting priorities. Another aspect can relate to an expectation to work as a team to define how and when stakeholders can be informed or engaged in the pay equity process. A further aspect can relate to communication, which includes development of a communication strategy regarding potential changes and the resources used to implement it. A macro-entity can use a pay equity engine configured to process compensation data for determination of pay equity. The pay equity engine can include a pay equity analysis process that may continuously monitor a compensation system, can identify disparities for both internal and external aspects, and can generate recommendations on how to resolve pay inequities and trigger one or more automatic actions to correct detected pay inequities exceeding a set threshold.

With continued reference to FIG. 2A, at 204, the example system 100 may be configured to group comparable jobs, positions, employment engagements, etc. (“comparable work”) based on the retrieved compensation data, and/or any other data that may be stored in a database and/or any other storage location. Data grouping can include defining and grouping job roles within the macro-entity. Comparable work may refer to positions within the macro-entity where the skills (derived based on a micro-entity experience and performed actions defined by historical data) and work attributes are similar. The comparison can be independent of a job location (e.g., geographical associations) in the macro-entity and/or what job families they may belong to. A grouping of comparable jobs may identify the roles that have similar responsibilities and value to the macro-entity.

FIG. 2B illustrates further details of the operation 204 shown in FIG. 2A. At 205, data relating to comparable work may be collected and validated by the example system 100. The data may be collected/validated based on one or more of the following example of, non-limiting, categories/parameters: micro-entity demographics, competencies/skills, compensation, job (employment position) content, and/or any combination thereof, and/or any other categories/parameters. For example, the categories/parameters may include, but are not limited to, micro-entity demographics (e.g., gender, ethnicity, race, tenure, time in position, etc.), compensation, job descriptions, job-related data elements, performance rating, years of relevant job-related experience, education, age, qualifications (e.g., micro-entity education, certifications, skills data, etc.), etc. The collected data may be reviewed and validated for accuracy and completeness. Further, data may be collected regularly and/or using any predefined intervals to ensure an accurate, up-to-date pay equity analysis. Additional data sources for such data collections may be included as they become available.

At 207, the example system 100 may analyze and document jobs. The example system 100 may review and document a list of jobs associated with a macro-entity. Macro-entity data may include jobs and micro-entity data (information of the personnel perform the jobs). A job analysis may refer to the systematic process of gathering the context of all jobs within a particular macro-entity (e.g., job descriptions, duties performed, positions, etc.). The collected job data may be organized, summarized, and/or documented in a format useful for making HR decisions, such as, for instance, benchmarking, identifying groups of similar jobs, and hiring.

A complete job description, which may be documented, may include information on one or more essential responsibilities and/or specific qualifications to perform that job successfully. The qualifications may also be used for hiring because they explain knowledge, skills, and abilities that may be required to perform the job. The comparison process may be useful in identifying similar jobs and understanding comparable work for equity purposes, and accurately benchmarking jobs to assess external competitiveness.

At 209, the example system 100 may be configured to perform analysis of the data related to comparable jobs. The analysis may be useful in developing a job worth hierarchy and providing an accurate scheme defining comparable work across similar, different, and/or across-macro-entity jobs. Job evaluation performed by the example system 100 may determine the relative worth of jobs to allow generation of a job structure, at 211. The value of a job may be based upon what a person performing the job may produce when performing the job successfully. Relative value may be defined by the similarities and/or differences between jobs that are identified in the job analysis process. Differences in work determine differences in pay, and similar jobs may be paid similarly. Job evaluation may closely align with the macro-entity's overall strategy and may include what adds value and helps achieve the objectives of the macro-entity. Aligning the pay of each job with its contributions to the macro-entity helps set pay for new, unique, and/or changing jobs. The alignment may also help micro-entities adapt to macro-entity changes by improving implementation of changes that are transparently reflected through accurate pay equity analyses.

At 211, the example system 100 may be configured to generate one or more job structures based on the analysis of the data relating to comparable work. The structure may be used to rank the jobs based on one or more parameters related to how the skills, duties, responsibilities, and compensable factors contribute to macro-entity goals. When generating a job structure, roles with comparable work may be assigned to the same grade unless there are substantial differences in job content. The groups of jobs for pay equity analysis may be referred to as similarly situated groups (SSGs) or similarly situated job groups (SSJGs). Progression up and down within defined grades may be determined by compensable factors, such as, skill proficiency, accumulated knowledge, and increased responsibility.

Referring back to FIG. 2A, at 206, once the comparable groups are established, the example system 100 may be configured to execute modeling of data to assess pay equity. The pay equity analysis may be broad in scope and may include an assessment of the pay gaps in the macro-entity. The example system 100 may execute one or more regression analyses to identify potentially existent pay disparities that cannot be explained by permissible factors. FIG. 2C illustrates further details of the modeling operation 206, according to some implementations of the current subject matter.

As shown in FIG. 2C, at 213, the example system 100 may be configured to determine pay gaps. The pay gap assessment may focus on, for example, gender and/or race across macro-entity hierarchy. The demographic distribution and/or pay levels of incumbents can be evaluated across one or more compensation tiers. The analysis may be used to evaluate compensation practices and/or pay levels to determine whether they are aligned with macro-entity goals for diversity, equity, and inclusion.

At 215, the example system 100 may be configured to execute a multivariate regression analysis to identify areas where pay disparities may exist. A regression analysis is a statistical technique used to model a macro-entity's compensation system based on interactions between multiple data elements. It may determine whether compensation decisions appear to be influenced by a given set of factors, including gender or other protected class attributes. A series of statistical tests can be performed and analyses may be executed to determine whether any significant pay differences exist among micro-entities of different gender, ethnicities, and other factors. The statistical analysis may further identify whether the differences may be reasonably explained by permissible job-related factors. The statistical analysis may further identify potential pay disparities that may, in turn, be targeted for further cohort and/or incumbent level analyses, at 217. For instance, the analysis may be executed for sample sizes of 30 or more micro-entities to best learn the effects of multiple variables on a given outcome.

At 217, the example system 100 may execute one or more cohort analyses. The pay equity analysis may identify pay differences that may be large enough to be statistically significant, and cannot be reasonably explained by reference to permissible factors. To minimize risk, non-defensible pay differences may be remediated through compensation adjustments. In some implementations, if pay differences are identified, an additional data review process, including an incumbent-level analysis, can be automatically triggered. The incumbent-level analysis, such as a cohort analysis, can be executed in one or more of the following cases: in response to determining that potential red-flags or pay disparities are identified from the statistical models, in response to determining that the factors that are used in the analysis do not adequately explain the salary that's currently paid; and/or, in response to determining that insufficient data or not enough micro-entities is provided to conduct statistical analysis with an accuracy exceeding a set accuracy threshold (e.g., greater than 80%).

The incumbent-level analysis may involve confirming that appropriate micro-entity groups were used. The example system 100 may also evaluate specific pay decisions by reviewing documents and conducting interviews with decision-makers. The may determine if there are legitimate factors to explain pay differences. In response to determining that the incumbent-level inspection is completed and additional job-related explanatory variables are identified, re-execution of the statistical (regression) models may be performed by the example system 100. The re-execution of the statistical (regression) models may be used to evaluate any secondary findings. If legitimate pay disparities exist, one or more remediation strategies may be identified and executed.

At 219, based on the analysis of cohorts, one or more recommendations may be generated by the example system 100. If pay differences cannot be reasonably explained by job-related factors, and if they are large enough to be statistically significant, an employer may need to consider compensation adjustments. The example system 100 may also model various potential adjustments and re-execute multivariate regression analyses to measure an impact of those adjustments.

Referring back to FIG. 2A, the example system 100 may be configured to execute benchmark external equity analysis. The benchmark external equity analysis can be based on market pricing that is used to determine the external value of a job based on the current compensation levels for comparable jobs in the market. In order to conduct accurate market pricing, the example system 100 may complete a job analysis and documentation process (as discussed above). The example system 100 may determine a particular job's duties, requirements, and competencies to perform the job at your macro-entity. Market pricing is an important step in the compensation administration process. Inaccurate market pricing can result in an ineffective compensation administration program, such as over- or under-paying micro-entities. The inaccurate market pricing can also impact a macro-entity's ability to attract and retain talented micro-entities.

Benchmarking, or job matching, may refer to matching a macro-entity job to the closest salary survey benchmark job. Various algorithms and/or processes may be used to determine market pricing and obtain insights that keep macro-entity competitive in the talent market. Market pricing may be performed by (1) selecting a relevant compensation survey data for most of the macro-entity's macro-entity jobs (e.g., 50% of macro-entity jobs may be market priced); (2) market pricing a job based on the minimum requirements of the job itself and not on the qualifications of a particular micro-entity; (3) determining components of the job being priced and a recruiting market where it competes (e.g., geography, industry, size of macro-entity, etc.); (4) determining a good “match,” e.g., when at least 70% of the duties may be similar; (5) adjusting the data and/or age data to ensure it aligns with the compensation philosophy; (6) for jobs that cannot be benchmarked, determining an accurate rate of pay within the macro-entity (e.g., non-benchmark roles may be compared to benchmark jobs that require similar levels of skill, knowledge or responsibility; alternatively, the job may be “slotted” between two relevant survey jobs); and (7) generating one or more salary structures and updating them based on market pricing: generating one or more salary structures by identifying groups of jobs that cluster together with similar pay values, and generating salary ranges with minimum and maximum values that represent the range of pay in the marketplace that the macro-entity has targeted in its competitive pay policy.

At 210, one or more communications relating to pay equity review may be generated and transmitted by the example system 100. To minimize risk and disruption, the example system 100 may be configured to generate and transmit consistent messaging that effectively manages expectations for both micro-entities and stakeholders. It is also important to note that communication is not a one-time effort. It may be executed periodically (e.g., at least quarterly), at pre-defined periods of time, when a significant change or transaction happens in the macro-entity like an acquisition or a merger, etc.

As part of the communication, a communication plan may be generated and transmitted. The communication plan may include one or more of the following: compensation philosophy, affirmation that the macro-entity believes in fair pay and explain why it is good for business, announcement that the macro-entity retained an outside expert to conduct a pay equity audit, training of managers on how to communicate with micro-entities about pay, training of compensation department's pay equity specialist, and/or any other information.

Moreover, compensation statements may also be transmitted to all micro-entities to demonstrate that the macro-entity is communicating transparently about pay. The statements may include each micro-entity's pay range plus their position-in-range (PIR), and the average PIR for other jobs in the grade. For transparency, it is important that all micro-entities understand where they sit among their peers and what opportunities there are for growth in the macro-entity. In some cases, an appropriate certification may be obtained. Certification may demonstrate that the macro-entity has completed a comprehensive pay equity audit and is committed to pay equity.

In some implementations, additional data may be obtained to assess success of the pay equity structure. For example, data related to assessment of awareness, attitudes, and engagement of micro-entities may be collected.

Referring back to FIG. 2A, at 212, the example system 100 may be configured to perform continuous updates and re-execution of the process 200 upon obtaining/receiving additional data related to pay equity. For example, the process 200 may be re-executed based on receiving updated job content, structures, and other areas data (e.g., a new hires, a promotion, a termination, or other key events that affect overall compensation) and/or according to a set schedule (with a particular frequency per year).

In some implementations, the update and hence, re-execution of the process 200 (and/or one or more operations 202-212) may be continuous. The may result in updating job and pay structure design, job description management processes, job leveling, and job evaluation methods, internal equity analysis, market benchmarking practices, merit and promotional increase processes, how you determine hiring pay rates, compensation, communication, and documentation, governance and degree of discretion by decision-makers, data collection, analysis, and technology optimization, including notifications when key attributes change, and/or any other data.

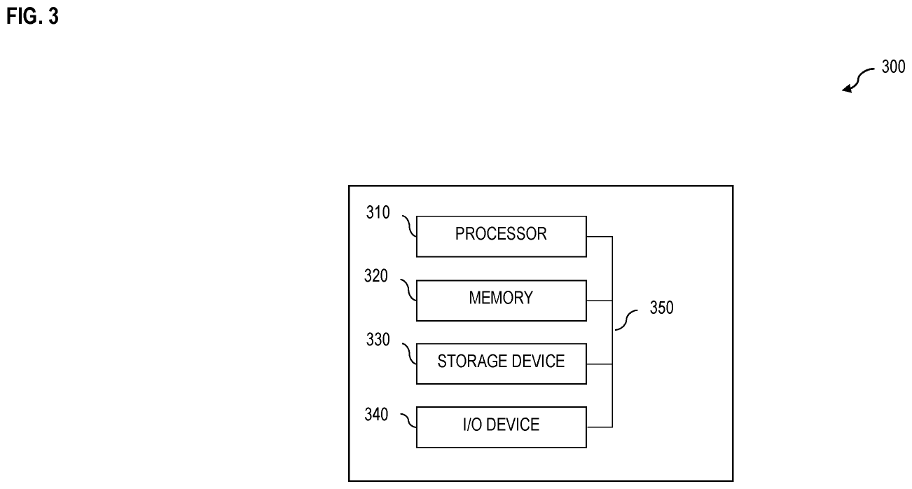

FIG. 3 depicts a block diagram illustrating a computing system 300 consistent with implementations of the current subject matter. For example, the system 300 can be used to implement the devices and/or system disclosed herein (e.g., host one or more aspect of FIG. 1). As shown in FIG. 3, the computing system 300 can include a processor 310, a memory 320, a storage device 330, and input/output devices 340. The processor 310, the memory 320, the storage device 330, and the input/output devices 340 can be interconnected via a system bus 350. The processor 310 is capable of processing instructions for execution within the computing system 300. Such executed instructions can implement one or more components of, for example, the trusted server, client devices (parties), and/or the like. In some implementations of the current subject matter, the processor 310 can be a single-threaded processor. Alternately, the processor 310 can be a multi-threaded processor. The processor may be a multi-core processor having a plurality or processors or a single core processor. The processor 310 is capable of processing instructions stored in the memory 320 and/or on the storage device 330 to display graphical information for a user interface provided via the input/output device 340.

The memory 320 is a computer readable medium such as volatile or non-volatile that stores information within the computing system 300. The memory 320 can store data structures representing configuration object databases, for example. The storage device 330 is capable of providing persistent storage for the computing system 300. The storage device 330 can be a floppy disk device, a hard disk device, an optical disk device, or a tape device, or other suitable persistent storage means. The input/output device 340 provides input/output operations for the computing system 300. In some implementations of the current subject matter, the input/output device 340 includes a keyboard and/or pointing device. In various implementations, the input/output device 340 includes a display unit for displaying graphical user interfaces.

According to some implementations of the current subject matter, the input/output device 340 can provide input/output operations for a network device. For example, the input/output device 340 can include Ethernet ports or other networking ports to communicate with one or more wired and/or wireless networks (e.g., a local area network (LAN), a wide area network (WAN), the Internet).

FIG. 4 illustrates an example method 400 for determining compensation (or pay) equity, according to some implementations of the current subject matter. The method 400 may be performed by any components of the example system 100 described with reference to FIG. 1, such as the data processing system 104 (shown in FIG. 1).

At 402, a user authentication is performed. In some implementations the user authentication is performed by a user device (e.g., user device 102 described with reference to FIG. 1) or by a data processing system (e.g., data processing system 104 described with reference to FIG. 1), at the request of the user device. The user authentication can include a verification of a user identity (e.g., registered user of the data processing system) and a user password. The verification of a user identity and/or a user password can include processing of a user identifier (e.g., name, employment position identifier, email address, etc.) and/or a biometric information (e.g., image, finger print, voice print, etc.) captured by a sensor (e.g., camera, microphone, keypad entry) of the user device.

At 404, in response to successful user authentication, a query for compensation data for an employment position associated with a macro-entity is received by the data processing system. The employment position can be defined by multiple parameters associated with a micro-entity (e.g., user of the user device). The parameters can include quantifiable values for skills (ranked based on relevance for macro-entity), expertise, experience (duration of applied skill), reviews (given by upper management), efficiency scores (determined based on time spent on projects), accuracy scores (determined based on errors associated with product quality), and any other quantifiable measures of an employment. The parameters can be automatically retrieved from a database (e.g., database 106 described with reference to FIG. 1) storing employment contracts including the parameters associated with the employment position and storing historical data including the parameters associated with the employment history (experience, reviews, etc.) of each micro-entity. In some implementations, the retrieved parameters can be displayed by the user interface of the user device with an option to add additional parameters from a list of parameters (including skills) associated with a selectable department of the macro-entity. The parameters can be displayed, by the user interface of the user device, on a dashboard with an option to select one or more parameters.

At 406, an origin of the compensation data request is verified, by the data processing system. For example, a user account can be restricted to select only parameters that are linked to the user' profile. The data processing system can verify that the user account is authorized to initiate a compensation data request and/or compensation data analysis for the selected asset. In some implementations, verification of the compensation data request origin can include determining whether the selection originates from a whitelisted server associated with user accounts authorized to initiate compensation data request for the selected micro-entity. For example, a micro-entity can be authorized to initiate compensation data requests for itself, while an admin and/or a supervising entity can be authorized to initiate compensation data requests for a selected set of micro-entities.

At 408, in response to the successful verification of the origin of the compensation data request, the compensation data (for the micro-entity and other similar employment positions associated with the macro-entity) is retrieved, by the data processing system, from the database. The compensation data can include historical compensation data indicating a mapping between parameters and the compensation data variation over time for the selected micro-entity. The compensation data can include external values associated with the macro-entity and other macro-entity having similar employment positions. The compensation data can be stored, in an encrypted way, for example, as hash values of compensation transactions stored in a distributed database (e.g., the distributed database 106, described with reference to FIG. 1) of a system (e.g., the example system 100, described with reference to FIG. 1).

At 410, the compensation data is processed, by the data processing system, to generate ranked employment positions, by grouping and ranking the similar employment positions associated with the macro-entity. For example, the compensation data is processed to match similar employment positions based on different parameter types and group one or more similar employment positions in the plurality of employment positions using one or more parameters in the plurality of parameters. For example, employment positions of experienced micro-entities are grouped separately from employment positions of mid-experienced micro-entities and employment positions of inexperienced micro-entities relative to an expertise field. Within each group, the employment positions can be ranked using the quantifiable measures, such that a micro entity with the highest number of skills, greatest experience, highest efficiency, and highest accuracy would be top ranked.

At 412, compensation gaps between the ranked employment positions are determined, by the data processing system, by executing a multivariate regression analysis of the ranked employment positions relative to their compensations. The multivariate regression analysis may include analyzing one or more cohorts of employment positions within the ranked employment positions. The compensation gaps can be indicative of a current and/or past difference (exceeding a compensation gap threshold, such as 5%) between an employment position rank of the selected micro-entity and a compensation relative to similarly ranked employment positions. The compensation gap threshold can be a static threshold or a dynamic threshold. The static threshold can include a set value. The dynamic threshold enables a comparison of the compensation gap with a threshold trend or range applicable to multiple types of compensations (e.g., bonuses, annual compensation rate increase, etc.).

At 414, the compensation gaps are processed, by the data processing system using a machine learning engine (e.g., at least one multilayer perceptron (MLP), at least one convolutional neural network (CNN), at least one recurrent neural network (RNN), at least one data encoder, at least one asset converter, and/or the like) configured to perform a convolution function, to generate one or more recommendations including a quantitative value for correcting the compensation gap. For example, the convolution function can process the historical compensation data and the current compensation data by performing the convolution function based on CNN providing the values representing the historical data and the current data as input to one or more neurons included in a convolution layer. In this example, the values representing the historical data and the current data can correspond to values representing micro-entity parameters, compensation, and/or macro-entity compensation trends (sometimes referred to as a receptive field). In some embodiments, each neuron is associated with a filter associated with a micro-entity expertise or employment field. A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex trend patterns (e.g., arcs, objects, and/or the like). In some embodiments, CNN performs the convolution function based on CNN multiplying the values provided as input to each of the one or more neurons included in first convolution layer with the values of the filter that corresponds to each of the one or more neurons. For example, CNN can multiply the values provided as input to each of the one or more neurons included in first convolution layer with the values of the filter that corresponds to each of the one or more neurons to generate a single value or an array of risk prediction values as an output. In some embodiments, the collective output of the neurons of first convolution layer is referred to as a convolved output. In some embodiments, where each neuron has the same filter, the convolved output is referred to as a feature map. In some embodiments, CNN provides the outputs of each neuron of first convolutional layer to neurons of a downstream layer. For purposes of clarity, an upstream layer can be a layer that transmits data to a different layer (referred to as a downstream layer). For example, CNN can provide the outputs of each neuron of first convolutional layer to corresponding neurons of a subsampling layer. In an example, CNN provides the outputs of each neuron of first convolutional layer to corresponding neurons of first subsampling layer. In some embodiments, CNN adds a bias value to the aggregates of all the values provided to each neuron of the downstream layer. For example, CNN adds a bias value to the aggregates of all the values provided to each neuron of first subsampling layer. In such an example, CNN determines a final value to provide to each neuron of first subsampling layer based on the aggregates of all the values provided to each neuron and an activation function associated with each neuron of first subsampling layer. In some implementations, the ML engine include a CNN configured to generate as output a subsampled convolved output representing a quantitative value for correcting the compensation gap. In some implementations, the quantitative value for correcting the compensation gap can be normalized relative to a macro-entity compensation range.

At 416, a notification is generated, by the data processing system, to be displayed by the user devices. For example, a first user device of a first user (e.g., micro-entity) and a second user device of a second user (e.g., supervisor of the micro-entity) can display the notification. In some implementations, the data processing system may transmit, to one or more user devices, one or more notifications including instructions for displaying an indication of a completion of an analysis of the compensation equity and the one or more generated recommendations. The recommendations can include actions to remedy a compensation that was identified as being below a set threshold for an associated job. The recommendations can include the (normalized) quantitative value for correcting the compensation gap, and a compensation remedy execution option that can enable a user to authorize implementation of the compensation remedy.

At 418, the compensation remedy action is triggered, by the data processing system. In some implementations, the user devices can receive a user input including a selection of a recommendation from the listed recommended actions. In some implementations, the compensation remedy action can be automatically initiated, if the compensation gap exceeds an action activation threshold (e.g., if the gap is greater than 10%). The results of the compensation remedy action can be transmitted by the data processing system, to be displayed by the user devices.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. The various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

The computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively, or additionally, store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the figures and/or described herein do not necessarily require the particular order shown, or sequential order, to achieve desirable results. Other implementations may be within the scope of the following claims.

What is claimed:

1. A system comprising:
one or more computer processors;
a database storing a plurality of documents, the plurality of documents comprising job related documents; and
a data processing system, executable upon the one or more computer processors, to perform operations comprising:
receiving a query for compensation data for an employment position associated with a macro-entity, the employment position being defined by a plurality of parameters associated with a micro-entity;
retrieving, from the database and by using the plurality of parameters, the compensation data for similar employment positions associated with the macro-entity;
processing the compensation data to generate ranked employment positions, by grouping and ranking the similar employment positions associated with the macro-entity;
determining one or more compensation gaps between the ranked employment positions, by executing a multivariate regression analysis comprising an analysis of one or more cohorts of employment positions within the ranked employment positions;
generating, by using a machine learning model comprising a convolution function configured to process the one or more compensation gaps, a recommendation for adjusting compensation associated with one or more employment positions; and
providing an instruction to display a notification comprising the recommendation.

2. The system of claim 1, wherein the operations further comprise:
determining, using a machine learning, a compensation equity for each employment position within groups of similar employment positions.

3. The system of claim 1, wherein the operations further comprise:
performing a user authentication;
determining whether the query for the compensation data originates from a whitelisted server; and
retrieving, from a database, via a secure gateway, the compensation data associated with the macro-entity.

4. The system of claim 1, wherein the compensation data is encrypted for transmission, via a secure gateway.

5. The system of claim 1, wherein the operations further comprise:
generating a notification indicating completion of an analysis of a compensation equity.

6. The system of claim 1, wherein the compensation data comprise data recorded over a past period of time, encrypted, and stored in a distributed database of a system.

7. The system of claim 1, wherein the compensation data comprise external values associated with the macro-entity.

8. A non-transitory computer-readable storage medium comprising programming code, which when executed by at least one data processor, causes operations comprising:
receiving a query for compensation data for an employment position associated with a macro-entity, the employment position being defined by a plurality of parameters associated with a micro-entity;
retrieving, from a database and by using the plurality of parameters, the compensation data for similar employment positions associated with the macro-entity;
processing the compensation data to generate ranked employment positions, by grouping and ranking the similar employment positions associated with the macro-entity;
determining one or more compensation gaps between the ranked employment positions, by executing a multivariate regression analysis comprising an analysis of one or more cohorts of employment positions within the ranked employment positions;
generating, by using a machine learning model comprising a convolution function configured to process the one or more compensation gaps, a recommendation for adjusting compensation associated with one or more employment positions; and
providing an instruction to display a notification comprising the recommendation.

9. The non-transitory computer-readable storage medium of claim 8, wherein the operations further comprise:
determining, using a machine learning, a compensation equity for each employment position within groups of similar employment positions.

10. The non-transitory computer-readable storage medium of claim 8, wherein the operations further comprise:
performing a user authentication;
determining whether the query for the compensation data originates from a whitelisted server; and
retrieving, from a database, via a secure gateway, the compensation data associated with the macro-entity.

11. The non-transitory computer-readable storage medium of claim 8, wherein the compensation data is encrypted for transmission, via a secure gateway.

12. The non-transitory computer-readable storage medium of claim 8, wherein the operations further comprise:
generating a notification indicating completion of an analysis of a compensation equity.

13. The non-transitory computer-readable storage medium of claim 8, wherein the compensation data comprise data recorded over a past period of time, encrypted, and stored in a distributed database of a system.

14. The non-transitory computer-readable storage medium of claim 8, wherein the compensation data comprise external values associated with the macro-entity.

15. A method comprising:
receiving a query for compensation data for an employment position associated with a macro-entity, the employment position being defined by a plurality of parameters associated with a micro-entity;
retrieving, from a database and by using the plurality of parameters, the compensation data for similar employment positions associated with the macro-entity;
processing the compensation data to generate ranked employment positions, by grouping and ranking the similar employment positions associated with the macro-entity;
determining one or more compensation gaps between the ranked employment positions, by executing a multivariate regression analysis comprising an analysis of one or more cohorts of employment positions within the ranked employment positions;
generating, by using a machine learning model comprising a convolution function configured to process the one or more compensation gaps, a recommendation for adjusting compensation associated with one or more employment positions; and
providing an instruction to display a notification comprising the recommendation.

16. The method of claim 15, further comprising:
determining, using a machine learning, a compensation equity for each employment position within groups of similar employment positions.

17. The method of claim 15, further comprising:
performing a user authentication;
determining whether the query for the compensation data originates from a whitelisted server; and
retrieving, from a database, via a secure gateway, the compensation data associated with the macro-entity, wherein the compensation data is encrypted for transmission, via a secure gateway.

18. The method of claim 15, further comprising:
generating a notification indicating completion of an analysis of a compensation equity.

19. The method of claim 15, wherein the compensation data comprise data recorded over a past period of time, encrypted, and stored in a distributed database of a system.

20. The method of claim 15, wherein the compensation data comprise external values associated with the macro-entity.
